(19) United States
(12) Patent Application Publication
(10) Pub. No.: US 2026/0317056 A1
(43) Pub. Date: Oct. 15, 2026

(54) STABLILIZING MAGNETIC FOUNDATION SYSTEM FOR OUTDOOR-USE ARTICLE

(71) Applicant: Connor Lamb, Cold Spring Harbor, NY (US)

(72) Inventor: Connor Lamb, Cold Spring Harbor, NY (US)

(21) Appl. No.: 19/645,564

(22) Filed: Apr. 13, 2026

Related U.S. Application Data
(60) Provisional application No. 63/787,177, filed on Apr. 11, 2025.

(51) Int. Cl. B65F 1/14

(52) U.S. Cl. CPC B65F 1/141

(57) ABSTRACT

A stabilizing foundation system for securing an outdoor-use article to a surface below the article. The system includes: a base unit having a first side configured to be adhered to the surface via a peel-and-stick adhesive pad of the base unit, the base unit including a first magnetic element; and a receiving unit affixed to a bottom portion of the article. The receiving unit includes a second magnetic element. The first or second magnetic element is a magnet, the other of the first or second magnetic element is an attracting magnet or a ferromagnetic plate, and the first and second magnetic elements are configured to magnetically attract each other, thereby securing the article to the surface via a magnetizing force.

### CROSS REFERENCE TO RELATED APPLICATION(S)

This application is related to and claims priority from U.S. Provisional Application No. 63/787,177, filed in the United States Patent and Trademark Office on Apr. 11, 2025, the entire content of which is incorporated by reference herein in its entirety.

### TECHNICAL FIELD

This disclosure relates generally to a stabilizing foundation system for an outdoor-use article. More particularly, this disclosure relates to a system for retaining portable outdoor-use articles such as empty trash containers to a ground surface under windy conditions and the like.

### DISCUSSION OF RELATED ART

Some portable outdoor-use articles such as residential and commercial trash containers (garbage cans) do not stay in place to a ground surface under conditions such as high wind or sloppy re-positioning to a previous upright position. In the case of trash cans (trash containers), either on property or on a designated street pickup throughout the day and night, windy conditions or sloppy re-positioning causes cans and trash to roll into streets or neighboring properties. Furthermore, trash cans or trash receptacles can become damaged in these conditions or cause harm to motorists and pedestrians.

At least one prior art method to secure a trash container to a ground surface, e.g., concrete, utilizes a mechanical means or a layer of adhesive to secure a fixed metal plate to the ground surface. A magnet within a housing inside the container holds the container in place via magnetic attraction to the metal plate. However, the implementation of the mechanical means or the layer of adhesive is cumbersome for homeowners and may be unreliable.

### SUMMARY

An embodiment of a magnetic foundation system for an outdoor-use article composed primarily of plastic or other non-ferromagnetic material uses two magnetically attracting magnets on each side of the base of the article to keep the article upright and stable.

Another embodiment of the magnetic foundation system substitutes one of the two magnets with a plate composed of ferromagnetic material (e.g., a steel plate).

In accordance with an embodiment, a stabilizing foundation system secures an outdoor-use article to a surface below the article. The system includes: a base unit having a first side adhered to the surface via a peel-and-stick adhesive pad of the base unit, where the base unit includes a first magnetic element. A receiving unit is affixed to a bottom portion of the article via an adhesive, a mechanical element, or an encasing structure at the bottom portion. The receiving unit includes a second magnetic element. The first or second magnetic element is a magnet, the other of the first or second magnetic element is a magnet or a ferromagnetic plate, and the first and second magnetic elements are configured to magnetically attract each other, thereby securing the article to the surface via a magnetizing force.

In accordance with an embodiment, a system includes the stabilizing foundation system summarized above, as well as the outdoor-use article.

In accordance with an embodiment, a stabilizing foundation system for securing an outdoor-use article to a surface below the article includes: a magnetic adhesive adherable to the surface; and a receiving unit configured to be affixed to a bottom portion of the article, where the receiving unit including a magnetic element. The magnetic element and the magnetic adhesive are configured to magnetically attract each other, thereby securing the article to the surface via a magnetizing force.

### BRIEF DESCRIPTION OF THE DRAWINGS

The above and other aspects and features of the disclosed technology will become more apparent from the following detailed description, taken in conjunction with the accompanying drawings in which like reference numerals indicate like elements or features. Various elements of the same or similar type may be distinguished by annexing the reference label with an underscore/dash and second label that distinguishes among the same/similar elements (e.g., _1, _2). However, if a given description uses only the first reference label, it is applicable to any one of the same/similar elements having the same first reference label irrespective of the second label. Elements and features are not necessarily drawn to scale in the drawings. In the drawings:

FIG. 1 is an exploded view of an embodiment of a stabilizing foundation system for an outdoor-use article.

FIG. 2 is an exploded view of another embodiment of a stabilizing foundation system for an outdoor-use article.

FIG. 3 is a perspective view of an example base unit employed in the system of FIG. 1 or FIG. 2.

FIG. 4A is a cross-sectional view of a magnetic element assembly, which is an example of a receiving unit and/or a base unit in the system of FIG. 1 or 2.

FIG. 4B is a cross-sectional view of a magnetic element assembly, which is an example of a receiving unit and/or a base unit in the system of FIG. 1 or 2.

FIG. 4C is a cross-sectional view of a peel-and-stick adhesive pad, which is an example securing component in a receiving unit and/or a base unit in the system of FIG. 1 or 2.

FIG. 5A is an example cross-sectional view of the system of FIG. 2;

FIG. 5B is another example cross-sectional view of the system of FIG. 2, in which an outdoor-use article has a recessed lower surface;

FIG. 6A is an exploded view of a magnetic element assembly configured with multiple magnetic elements according to an embodiment.

FIG. 6B is a perspective view of the magnetic element assembly of FIG. 6A in an assembled state.

FIG. 6C is a side view of the magnetic element assembly of FIG. 6B in an assembled state.

FIG. 7 is a side view of an embodiment of a stabilizing foundation system for an outdoor-use article, in which multiple magnetic element units are employed in conjunction with a single base unit; and

FIG. 8 is a cross-sectional view of another embodiment of a stabilizing foundation system for an outdoor-use article, in which a magnetic adhesive is substituted for a base unit in the system of FIG. 1 or 2.

### DETAILED DESCRIPTION OF EMBODIMENTS

The following description, with reference to the accompanying drawings, is provided to assist in a comprehensive understanding of certain exemplary embodiments of the technology disclosed herein for illustrative purposes. The description includes various specific details to assist a person of ordinary skill the art with understanding the technology, but these details are to be regarded as merely illustrative. For the purposes of simplicity and clarity, descriptions of well-known functions and constructions may be omitted when their inclusion may obscure appreciation of the technology by a person of ordinary skill in the art.

Embodiments of the inventive concept provide a stabilizing foundation system to keep portable outdoor-use articles such as trash cans (“garbage cans”) in place temporarily during a designated trash pick-up day or permanently outside the house or business. This may achieved through a magnetic foundation that permanently attaches one of a pair of magnetic elements, (each being a magnet or ferromagnetic securing plate) to daily surfaces (e.g., concrete, asphalt, brick, macadam, stone, gravel, pavers stone, cobblestone, resin-bound or resin-bonded material, et.) using a peel-and-stick adhesive pad, e.g., a butyl adhesive pad (a “base pad”) to secure to the ground. The other magnetic element (a “receiving unit”) is secured at a bottom portion of the article, either just inside the bottom surface or on the bottom exterior surface of the article with an adhesive (or equivalent material/attachment means). The magnetic elements keep the article in place against outdoor conditions when the article with the receiving unit is on top of the base unit. The magnetic force is designed such that the article can still be moved without excessive human effort. In the case of a trash can, the magnetic force may be designed to be in a range allowing the trash can to still be easily separated when the trash can needs to be moved on garbage pickup days or during other household events.

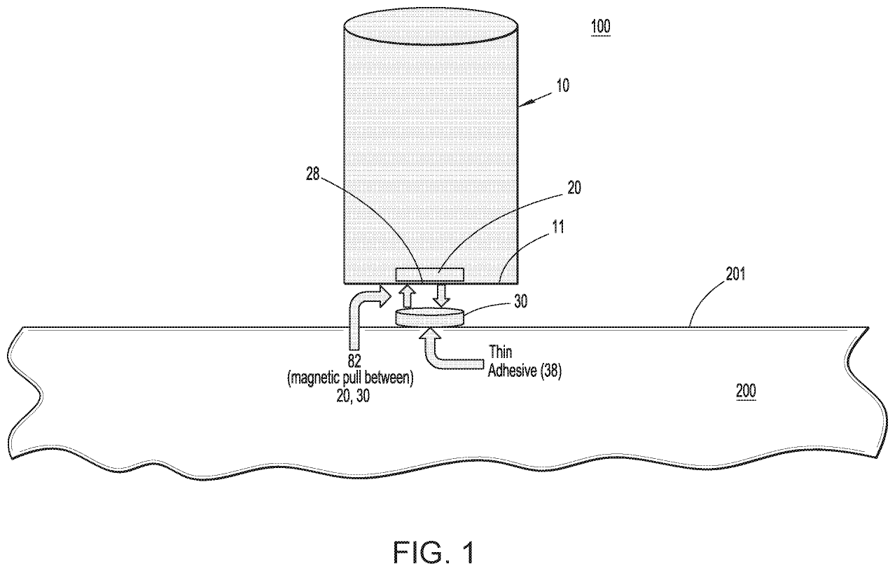

FIG. 1 is a perspective view of an example stabilizing foundation system, 100, for securing an outdoor-use article 10 according to an embodiment. System 100 includes a base unit 30 that includes a first magnetic element (e.g., 32, 432, 432′, 432″, shown in FIGS. 3-6C, not shown in FIG. 1), and a “receiving unit” 20 (a receiver of a magnetic attraction force) that includes a second magnetic element (e.g., 432, 432′, 432″ described later). In the embodiment of FIG. 1, the article 10 is a cylindrical container (a cylinder with a closed base) such as a trash can. In general, article 10 in FIG. 1 may be at least partially hollow such that receiving unit 20 is secured to an inner surface 11 of a bottom portion of article 10. In other embodiments such as those described below in which receiving unit 20 is attached to an exterior surface of article 10, article 10 need not be at least partially hollow. Some other examples of outdoor-use articles 10 include chairs, umbrellas with stands, and tents. In general, for embodiments described herein, article 10 in FIG. 1 can be any portable outdoor use article having a base or other lower portion to which a receiving unit 20 can be practically mounted and magnetically coupled to a base unit 30.

Each of the first magnetic element and the second magnetic element is a magnet (i.e., a permanent magnet) or a ferromagnetic plate. When the first magnetic element (within base unit 30) is a magnet, the second magnetic element (within receiving unit 20) is also a magnet, or is a ferromagnetic plate, e.g., a carbon steel plate. When the first magnetic element is a ferromagnetic plate, the second magnetic element is a magnet.

Base unit 30 further includes a peel-and-stick adhesive pad 36, which includes a substrate, an adhesive layer directly disposed on the substrate, and a plastic strip covering the adhesive layer (all exemplified hereinbelow). One example of adhesive pad 36 is a butyl adhesive pad (a peel-and-stick pad having a substrate composed primarily or entirely of butyl). Receiving unit 20 may also include a peel-and-stick adhesive pad 36 to secure receiving unit 20 to article 10. Base unit 30 is secured to an intended external surface 201 of an external support structure 200, e.g., a street or a sidewalk, using adhesive pad 36. It is noted here that reference in the description and drawings herein to “peel-and-stick adhesive pad” encompasses such an adhesive pad in a state either prior to, or after, the plastic strip is peeled off, depending on the structure (e.g., assembled or unassembled state) or method step being discussed (e.g., prior to being adhered to another element or after being adhered to the other element).

Receiving unit 20 is disposed inside the article 10 and secured to the inner (e.g., inner bottom) surface 11 via an adhesive (e.g., of an integrated peel-and-stick adhesive pad 36) or a mechanical fixation element such as screws, clips, etc. Alternatively, receiving unit 20 is encased within an interior encasing structure within the bottom portion of article 10. When article 10 is on top of the base unit 30, article 10 is secure in its foundation and, due to magnetic attraction 82, will not move off the exterior surface 201 absent a force above a predetermined threshold. (When a pair of magnets are employed for the respective first and second magnetic elements, a north pole of the first magnetic element always faces a south pole of the second magnetic element, or vice versa, to produce the magnetic attraction.) The predetermined threshold may be an expected force from human intervention or wind speeds higher than a certain wind threshold. In the case where article 10 is a trash can, when the can needs to be emptied, relocated (whether in a filled or empty state), etc. it can easily be disengaged from the base unit 30 using suitable human pull.

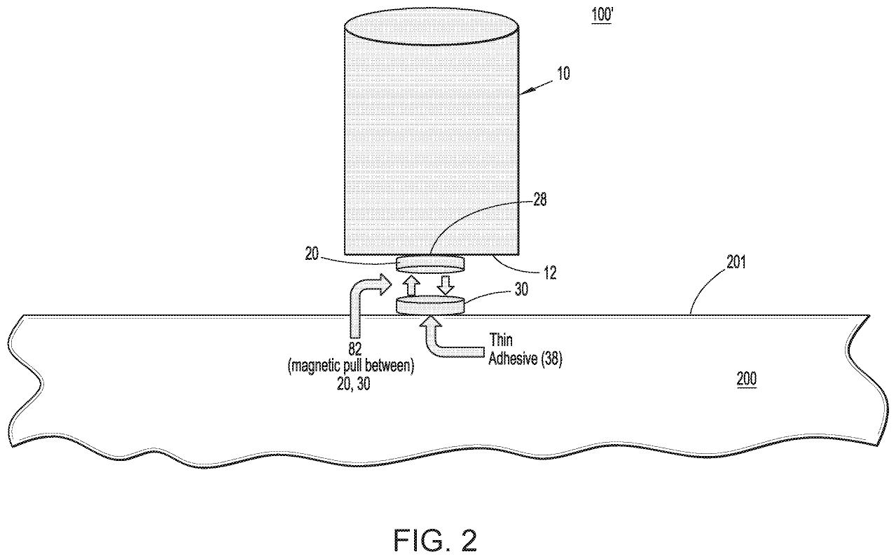

FIG. 2 is a perspective view of another example stabilizing foundation system, 100′, for an outdoor-use article according to an embodiment. System 100′ differs from system 100 described above in that receiving unit 20 is secured to an exterior bottom surface 12 of the bottom portion of the article 10, rather than to the interior surface 11. Otherwise, other aspects of system 100′ are the same as those for system 100. Since receiving unit 20 is secured to the exterior bottom surface 12, the thickness of a bottom wall of article 10 does not separate receiving unit 20 and the upper surface of base unit 30 when article 10 is magnetically engaged with base unit 30. Thus, a smaller magnet may be employed for the second magnetic element (within receiving unit 20) and/or for the first magnetic element (within base unit 30) in system 100′ to achieve the same magnetic force as in system 100. Receiving unit 20 in system 100′ may be secured to exterior bottom surface 12 using a peel-and-stick adhesive pad, an adhesive paste, or a mechanical means, or any combination of these.

FIG. 3 is a perspective view of an example base unit 30 that may be employed in system 100 and/or 100′. Note that the horizontal profile of base unit 30 may vary from embodiment to embodiment and may be designed in part based on the horizontal profile of the base of article 10. For example, FIG. 1 depicts base unit 30 having a circular profile in the horizontal plane, whereas FIG. 3 depicts base unit 30 having a rectangular profile.

As shown in FIG. 3, base unit 30 may include a protective casing (or coating) 34, a first magnetic element 32 (i.e., at least one permanent magnet or a ferromagnetic element) and peel-and-stick adhesive pad 36. Protective casing 34 may be composed primarily or entirely of a non-ferromagnetic material such as rubber, e.g., ethylene propylene diene rubber (EPDM), or a plastic. Protective casing 34 houses first magnetic element 32, e.g., a magnet or ferromagnetic plate (shown in phantom in FIG. 3). Adhesive pad 36 may be integrated with protective casing 34. Adhesive pad 36 may include a lower plastic strip (a “peel-off layer”) and an adhesive layer 38, e.g., a butyl adhesive (an adhesive compatible with a butyl substrate), that is exposed when the plastic strip is peeled off. When the adhesive is so exposed, base unit 30 may then be pressed against the external surface 201 of the street, sidewalk, etc. 200 to form an adhesive bond. In other embodiments, protective casing 34 is omitted. In this case, when article 10 is placed atop and magnetically engages with base unit 30, the upper surface of the first magnetic element may directly contact the lower surface 12 of article 10 when employed in system 100 of FIG. 1, or directly contacts the lower surface of receiving unit 20 when employed in system 100′ of FIG. 2.

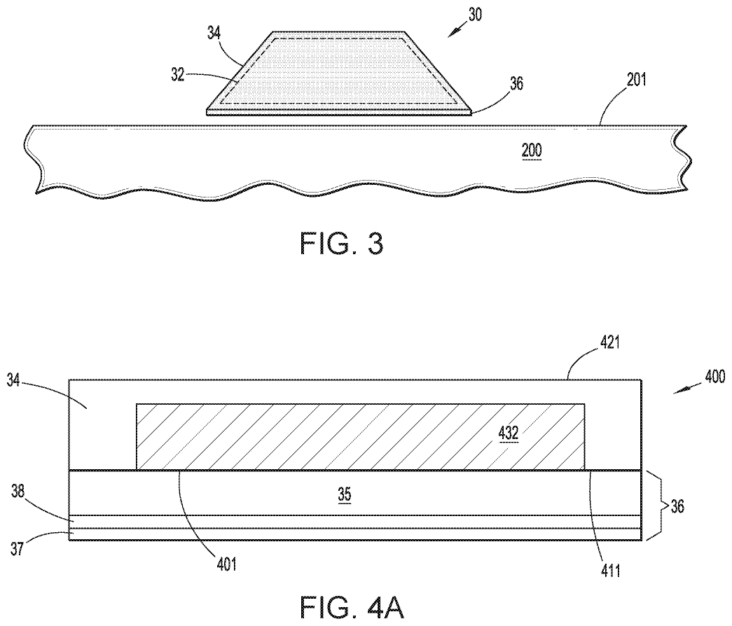

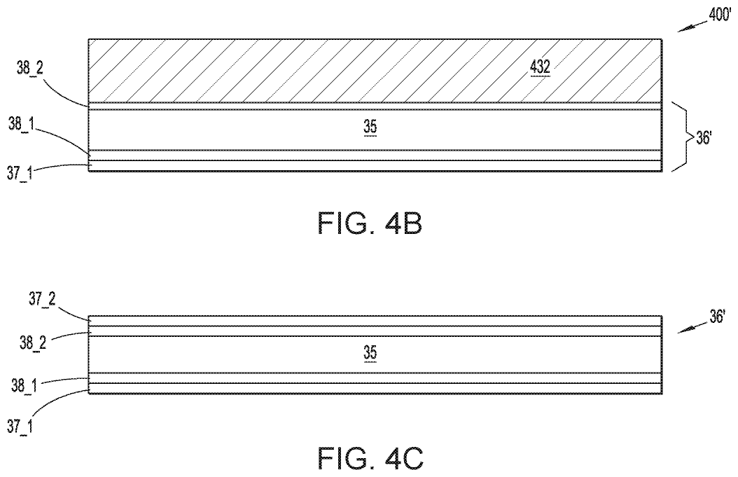

FIG. 4A is a cross-sectional view of a magnetic element assembly, 400, which is an example of receiving unit 20 and/or base unit 30 in the system of FIG. 1 or FIG. 2. Magnetic element assembly 400 is also an example of base unit 30 illustrated in FIG. 3. Magnetic assembly 400 includes a magnetic element 432, protective casing 34, and peel-and-stick adhesive pad 36. Magnetic element 432 is an example of first magnetic element 32 when assembly 400 is employed as a base unit 30, and is an example of the second magnetic element of receiving unit 20 when assembly 400 is employed as a receiving unit 20.

Adhesive pad 36 includes a pad substrate 35, e.g., composed primarily or entirely of butyl; an adhesive layer 38; and a plastic strip (peel-off layer) 37. As mentioned above, when plastic strip 37 is peeled off, adhesive layer 38 is exposed and, when assembly 400 is employed as a base unit 30, the exposed adhesive layer 38 may then be pressed against external surface 201 to secure base unit 30 to exterior support structure 200 via adhesive bond. When assembly 400 is employed as a receiving unit 20 and plastic strip 37 is peeled off, the exposed adhesive layer 38 may then be pressed against inner surface 11 of article 10 in system 100, or against the external bottom surface 12 of article 10 in system 100′, to secure receiving unit 20 to article 10.

Casing 34 may have an exterior surface 421 (“first surface”) and an opposite, interior surface 411 (“second surface”). Casing 34 may be secured to pad substrate 35 via a suitable adhesive or via mechanical elements. For example, an upper plastic strip 37 and an upper adhesive layer 38 may have been attached to the upper surface of substrate pad 35 (in the view of FIG. 4A). In a final step of assembling assembly 400, prior to placing casing 34 and magnetic element 432 against pad substrate 35, the upper plastic strip 37 may have been peeled off, exposing the upper adhesive layer 38. Then, a lower surface 401 of magnetic element 432 and lower surface 411 of casing 34 may have been pressed against the upper adhesive layer 38, thereby securing both magnetic element 432 and casing 34 to pad substrate 35.

FIG. 4B is a cross-sectional view of a magnetic element assembly, 400′, which is an example of a receiving unit 20 and/or a base unit 30 in system 100 of FIG. 1 or system 100′ of FIG. 2. Assembly 400′ differs from assembly 400 discussed above by omitting casing 34. Assembly 400′ includes a magnetic element 432; a pad substrate 35; an upper adhesive layer 38_2 adhering pad substrate 35 to magnetic element 432; lower adhesive layer 38_1; and lower plastic strip 37_1. The external surface of magnetic element assembly 400′ may be coated in one embodiment with a thin protective coating, e.g., polysilicon, and may be uncoated in another embodiment. Whether or not the external surface is coated, the magnetic coupling between magnetic element 400′, whether used for base unit 30 and/or receiving unit 20, and the magnetically coupled complementary receiving unit 20 and base unit 30, respectively, in system 100 or 100′, may be a stronger magnetic coupling as compared to using magnetic element assembly 400 in both the receiving unit 20 and base unit 30. This is because the casing 421 is omitted in one or both of the receiving unit 20 and base unit 30 when at least one assembly 400′ is included.

FIG. 4C is a cross-sectional view of a peel-and-stick adhesive pad, 36′, which is an example securing component in receiving unit 20 and/or base unit 30 in system 100 or 100′ of FIG. 1 or 2. Adhesive pad 36′ is also an example of adhesive pad 36 of assembly 400. Adhesive pad 36′ includes upper adhesive layer 38_2 and upper plastic strip 37_2 at the upper surface of pad substrate 35, and lower adhesive layer 38_1 and lower plastic strip 37_1 at the lower surface of pad substrate 35. To secure adhesive pad 36′ to magnetic element 432 in assembly 400 or 400′, upper plastic strip 37_2 is peeled off to expose upper adhesive layer 38_2, which is then pressed against magnetic element 432 as described above.

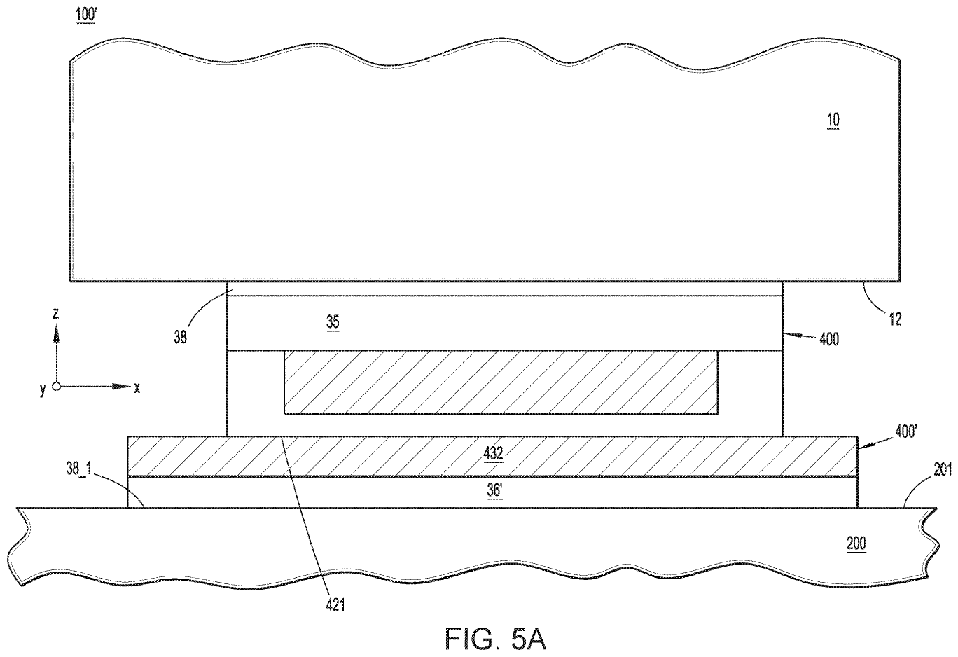

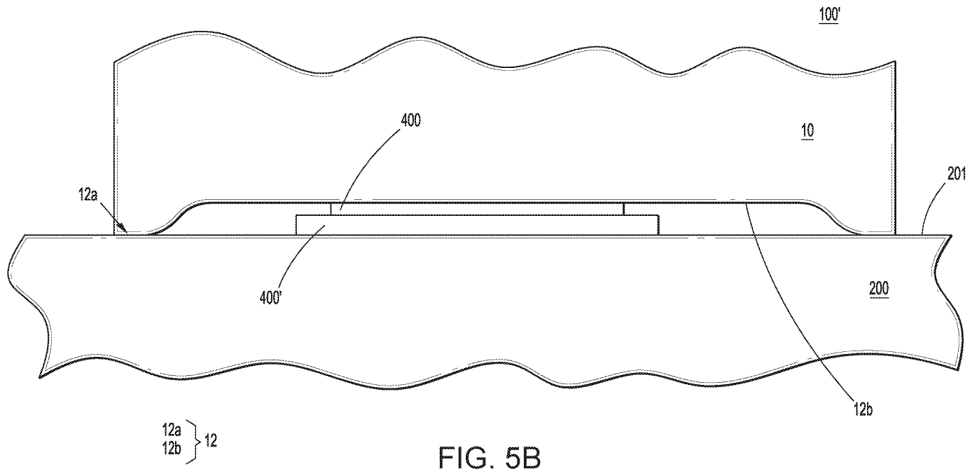

FIG. 5A is an example cross-sectional view of the stabilizing foundation system 100′ of FIG. 2 when article 10 is magnetically engaged with base unit 30. In FIG. 5A, magnetic element assembly 400′ is utilized as an example of base unit 30, and magnetic element assembly 400 is utilized as an example of receiving unit 20. Thus, adhesive layer 38 of assembly 400 is adhered to lower surface 12 of article 10. As illustrated, when article 10 is atop assembly 400′ (base unit 30), first surface 421 of assembly 400 is pulled against the upper surface of magnetic element 432 of assembly 400′ via magnetic attraction, securing article 10 to external surface 201.

FIG. 5B is another example cross-sectional view of the system of FIG. 2, in which an outdoor-use article 10 has a recessed lower surface. Otherwise, FIG. 5B illustrates the same configuration of FIG. 5A; thus, redundant description will be omitted. In FIG. 5B, lower surface 12 of article 10 has a central region 12b and a peripheral region 12a that is lower than central region 12b. The thicknesses of assembly 400 and 400′ may be such that when article 10 is magnetically coupled to assembly 400′ as shown, peripheral region 12a may contact external surface 201, thereby stabilizing article 10 further. In an embodiment, the combined thickness of assembly 400 and 400′ is smaller than the vertical (z direction) distance between surface 12a and surface 12b. Thus, when peripheral region 12a contacts external surface 201, a small gap exists between assembly 400 and 400′ while they magnetically attract each other.

Embodiments such as system 100 and 100′ employing the peel-and-stick adhesive pad 36 are advantageous over a system that might use a “squirt-on” or “pour-on” adhesive between the bottom of a steel plate (as in a prior art system) and the street, in that the set-up is faster and easier, superior control of the adhesive connection is achievable, and the adhesive connection is more reliable.

Embodiments with two magnets (as opposed to one magnet and one metal plate) may allow the adhesive pad 36 adhered to the exterior surface 201 (street, sidewalk, etc.) to have a smaller profile at least in the horizontal plane.

The peel-and-stick adhesive pad employed in embodiments of the inventive concept may have at most a single peel-off layer on a first side, configured to adhere to the surface, and a second side integrated with the base unit.

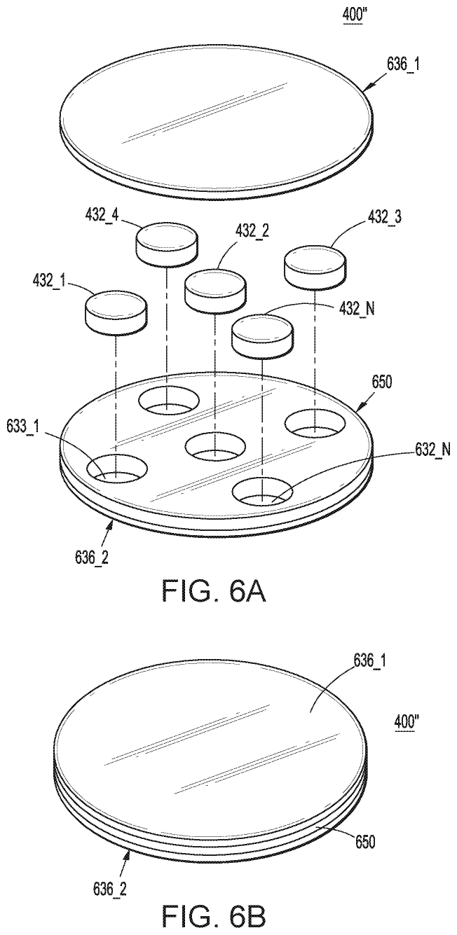

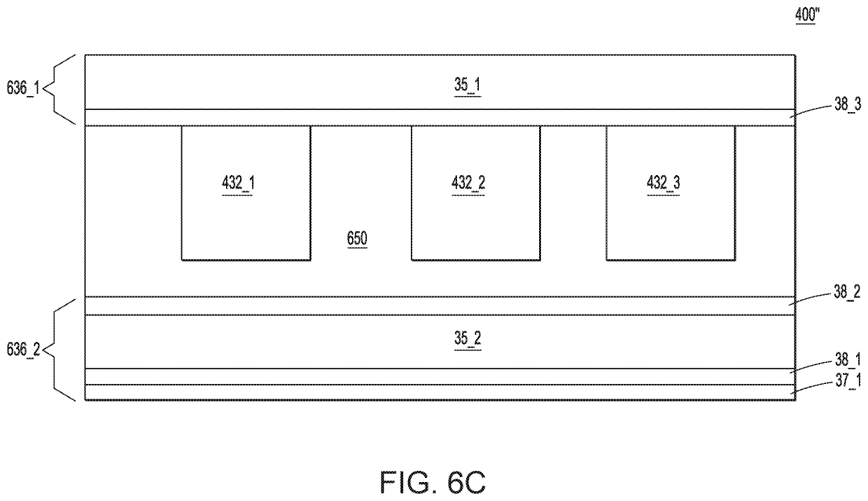

FIG. 6A is an exploded view of a magnetic element assembly, 400″, which is an example of a receiving unit 20 and/or a base unit 30 in system 100 of FIG. 1 or system 100′ of FIG. 2. FIG. 6B is a perspective view of the assembly 400″ in an assembled state. FIG. 6C is a cross-sectional view of the assembly 400″. Referring collectively to FIGS. 6A-6C, assembly 400″ includes a plurality of segregated magnets 432_1 to 432_N which together comprise an example of magnetic element 432 (which is an example of first magnetic element 32 of base unit 30 or the second magnetic element of receiving unit 20). In general, N is two or more. In the illustrated example of FIG. 6A, N=5, where magnetic element 432_2 is a centrally located element and the remaining elements are annularly distributed about the periphery of assembly 400″. Here, assembly 400″ is embodied as a circular disc (“puck”), but other shapes are contemplated.

Magnetic element assembly 400″ in its assembled state may include a first peel-and-stick adhesive pad 636_1 (with its plastic strip 37 already peeled off), a second peel-and-stick adhesive pad 636_2, and magnetic elements 432_1 to 432_N secured in respective sockets 633_1 to 633_N of a retaining substrate 650. Retaining substrate 650 is composed of a non-ferromagnetic material such as primarily or entirely EPDM. Retaining substrate 650 not only retains magnetic elements 432 but also includes a peripheral portion outside the periphery of sockets 633 that protects magnetic elements 432 from the external environment, in conjunction with adhesive pads 636_1 and 636_2.

As shown in FIG. 6C, an adhesive layer 38-3 of adhesive pad 636_1 may directly contact both an upper surface of retaining substrate 650 and the upper surfaces of magnetic elements 432, which may be coplanar with the upper surface of retaining substrate 650 in the assembled state. Thus, to assemble assembly 400″, magnetic elements 432 may first be placed within sockets 633; the plastic strip of adhesive pad 636_1 may be removed; and the exposed adhesive pad 636_1 may be pressed against the upper surfaces of magnetic elements 432 and retaining substrate 650 with the exposed adhesive layer 38-3 facing the upper surfaces. This adheres adhesive pad 636_1 to retaining substrate 650 and secures magnetic elements 432. (Note that magnetic elements 432 may have a height slightly less than that of sockets 633 and placed therein with upper surfaces set slightly below the upper surface of retaining substrate 650, so that the adhesive layer 38-3 adheres just to retaining substrate 650 but not to magnetic elements 650.) Thereafter (or prior thereto), second adhesive pad 636_2 may be adhered to the lower surface of retaining substrate 650 by pressing adhesive layer 38_2 against it (which is exposed following removal of an upper plastic strip 37_2, akin to that shown in FIG. 4C).

By embodying multiple segregated magnetic elements, whether as individual magnets or individual ferromagnetic elements in magnetic assembly 400″, when utilized in system 100 and/or 100′ as receiving unit 20 and/or base unit 30, magnetic coupling performance results of system 100 and/or 100′ may be improved. For example, a haptic experience to the user when removing article 10 from base unit 30 may be improved, resulting in an improved user experience. The improved haptic effect may be particularly noticeable when the segregated magnetic elements 432_1 to 432_N are magnets.

The peel-and-stick adhesive pads 36, 36′ and 636 as described above, when used as part of base unit 30, may each be a permanent adhesive pad adapted to adhere to the surface 201 and remain in place for an expected lifetime of base unit 30.

Examples of support structure 200 may include asphalt, concrete, brick, macadam, stone, gravel, pavers stone, cobblestone, a resin-bound or resin-bonded material, and a material including rubber.

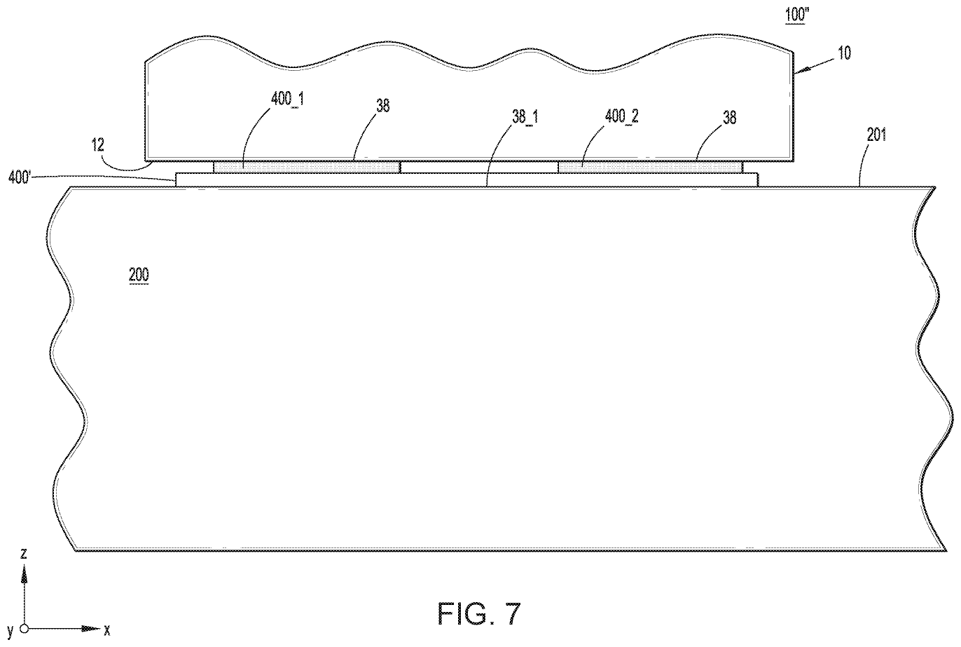

FIG. 7 is a side view of a stabilizing foundation system, 100″, for an outdoor-use article. In system 100″, multiple receiving units 20 are employed in conjunction with a single base unit 30. In the shown example, first and second magnetic element assemblies 400_1 and 400_2, each an example of a receiving unit 20, are attached to lower surface 12 of article 10. (Note that any of magnetic assemblies 400′ or 400″ are examples of assemblies 400_1 and/or 400_2). Magnetic assembly 400′ is an example of base unit 30. Magnetic assembly 400′ of FIG. 7 has a larger horizontal profile (in the x-y plane of FIG. 7) than that of each of assemblies 400_1 and 400_2. As one example of the particular utility of system 100″, article 10 may have a rectangular profile in the horizontal plane, with a longer rectangular dimension in the x direction than the y direction. Also, the horizontal profile of magnetic assembly 400′ of FIG. 7 may have a longer x-dimension than its y-dimension. Accordingly, magnetic assembly 400′ may have a horizontal profile similar in proportion to that of article 10, which results in improved magnetic coupling performance results with respect to article 10, as compared to that achievable with system 100 or 100′, particularly when the first magnetic element of magnetic assembly 400′ is a ferromagnetic (e.g., steel) plate. (Note that magnetic assembly 400′ in FIG. 7 may be substituted with a magnetic assembly 400 described above.)

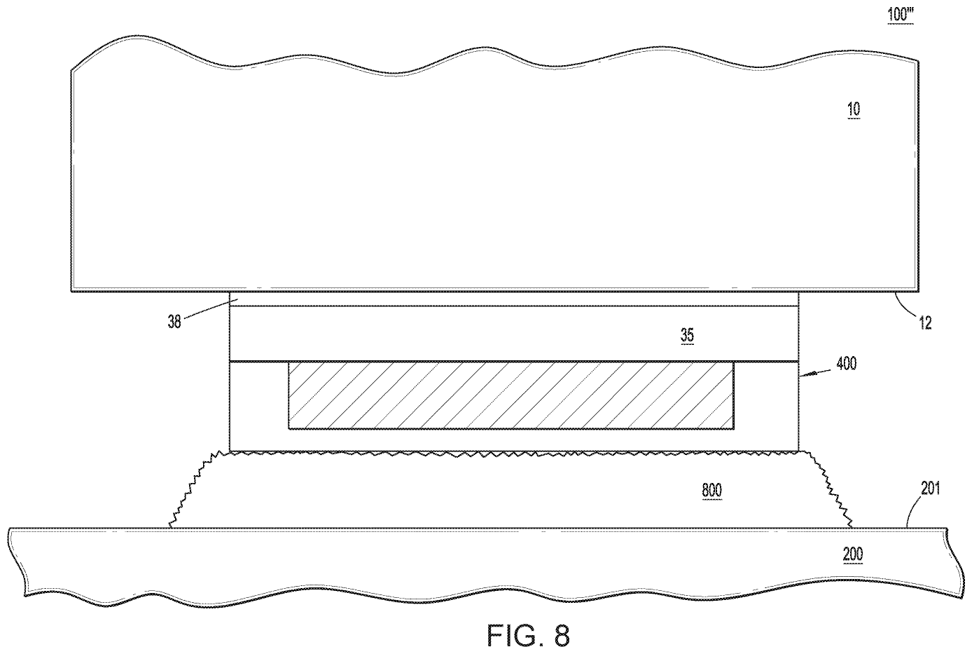

FIG. 8 is a cross-sectional view of another embodiment of a stabilizing foundation system, 100′″, for an outdoor-use article. In system 100′″, a cured magnetic adhesive 800 (adhered to external surface 201) is substituted for the base unit 30 in systems 100, 100′ or 100″ of FIGS. 1, 2 or 7. For example, to form magnetic adhesive 800, surface 201, such as concrete, pavement, decking, or other ground materials, may have been treated, coated, or infused with a composition containing ferromagnetic or magnetically responsive particles. Some examples of such particles may include: ferrites such as a nickel-zinc ferrite of a manganese-zinc ferrite; and iron-based powders such as a reduced iron power or iron alloys (e.g., Fe—Ni. Fe—Si); and rear-earth magnetic powders such as samarium-cobalt (SmCo) or neodymium-iron-boron (NdFeB), and any suitable combination thereof. The composition may further include a binder to cure the composition, such as: a thermosetting polymer, e.g., polyurethane, epoxy resins or silicon; a thermoplastic, or a UV-curable resin. The composition may further include additives to optimize performance, such as dispersants plasticizers, curing agents, thixotropic agents or coupling agents.

This treatment may have been applied in liquid, paste, or coating form and subsequently cured or set to create a magnetically receptive region 800. Cured magnetic adhesive 800 may perform the same function as base unit 30, i.e., magnetically attracting receiving unit 20 (e.g., magnetic assembly 400) when article 10 is placed over adhesive 800. Advantageously, this approach enables a magnetic element (e.g., magnetic assembly 400) to directly couple with surface 201 without requiring a separate base unit (or base plate) component.

The first magnetic element may be a permanent magnet, and the second magnetic element is a corresponding, attracting permanent magnet, both magnets being configured with sufficient strength to secure the outdoor-use article against a predetermined amount of wind or external forces.

The butyl adhesive pad or other type of pad 36, 636 is compatible with a variety of surface materials, including asphalt, concrete, brick, stone, gravel, pavers stone, cobblestone, resin-bound or resin-bonded, etc.

The first magnetic element (e.g., 32, 432) may be housed in a protective casing that shields the magnet from environmental damage, such as moisture or debris. The base unit and magnetic elements may be constructed from weather-resistant materials that protect them from damage caused by exposure to outdoor environmental conditions, including rain, snow, and extreme temperatures.

The first and second magnetic elements (and correspondingly, the receiving unit and base unit) are available in various shapes and sizes (including round, rectangular, square, bevel, etc.) allowing for customization to securely attach the device to different surface types, including bricks, driveways, paver stone, cobble stone and other outdoor surfaces. The magnetic elements are also customizable for aesthetic purposes. embodiments of the inventive concept such as those described herein may be beneficial to homeowners, business owners, etc. by providing a relatively simple, cost-effective and reliable way to keep their garbage cans secure to the street, sidewalk, or surface and their placeholders outside their home for short, long or permanent periods of time, while also allowing for customizable options to have the base unit blend in to the natural aesthetic of the surface or home (e.g., a brick design and shaped base unit.)

While the technology described herein has been particularly shown and described with reference to example embodiments thereof, it will be understood by those of ordinary skill in the art that various changes in form and details may be made therein without departing from the spirit and scope of the claimed subject matter as defined by the following claims and their equivalents.

What is claimed is:

1. A stabilizing foundation system for securing an outdoor-use article to a surface below the article, the system comprising:
a base unit having a first side configured to be adhered to the surface via a peel-and-stick adhesive pad of the base unit, the base unit including a first magnetic element;
a receiving unit configured to be affixed to a bottom portion of the article, the receiving unit including a second magnetic element,
wherein the first or second magnetic element is a magnet, the other of the first or second magnetic element is an attracting magnet or a ferromagnetic plate, and the first and second magnetic elements are configured to magnetically attract each other, thereby securing the article to the surface via a magnetizing force.

2. The stabilizing foundation system of claim 1, wherein the bottom portion is a lowest exterior surface of the article.

3. The stabilizing foundation system of claim 1, wherein the bottom portion is an inner base wall of the article.

4. The stabilizing foundation system of claim 1, wherein the peel-and-stick pad is a first peel-and-stick pad, and the receiving unit includes a second peel-and-stick pad configured to adhere the receiving unit to the bottom portion.

5. The stabilizing foundation system of claim 1, wherein the peel-and-stick adhesive pad is a butyl adhesive pad.

6. The stabilizing foundation system of claim 1, wherein the peel-and-stick adhesive pad comprises:
a first peel-off layer on a first peel-and-stick side;
a first adhesive layer adjacent to the first peel-off layer, the first adhesive layer being exposed when the first peel-off layer is peeled off, wherein the exposed first adhesive layer is configured to adhere to the surface;
and a second peel-off layer on an opposite side;
a second adhesive layer adjacent to the second peel-off layer, the second adhesive layer being exposed when the second peel-off layer is peeled off, wherein the exposed second adhesive layer is configured to adhere to the second magnetic element; and
a substrate between the first and second adhesive layers.

7. The stabilizing foundation system of claim 1, wherein the peel-and-stick adhesive pad is a permanent adhesive pad adapted to adhere to the surface and remain in place for an expected lifetime of the second magnetic element.

8. The stabilizing foundation system of claim 1, wherein the surface is a road surface.

9. The stabilizing foundation system of claim 1, wherein the surface is a sidewalk surface.

10. The stabilizing foundation system of claim 1, wherein the surface is asphalt, concrete, brick, or a surface that includes a rubber material.

11. The stabilizing foundation system of claim 1, wherein the first magnetic element is a permanent magnet, and the second magnetic element is a corresponding, attracting permanent magnet, both the first and second magnets being configured with sufficient strength to secure the article against a predetermined amount of wind or external forces.

12. The stabilizing foundation system of claim 1, wherein the peel-and-stick adhesive pad is compatible with each of a plurality of surface materials including asphalt, concrete, brick, stone, gravel pavers stone, cobblestone, a resin-bound surface material and a resin-bonded surface material.

13. The stabilizing foundation system of claim 1, wherein the base unit includes a protective casing housing the first magnetic element, the protective casing shielding the first magnetic element from an external environment.

14. The stabilizing foundation system of claim 1, wherein the first and/or second magnetic element comprises a plurality of segregated magnets.

15. The stabilizing foundation system of claim 14, wherein the plurality of segregated magnets includes a first magnet centrally disposed within a first socket within a substrate, and multiple magnets annularly disposed about a periphery of the substrate within respective other sockets within the substrate.

16. The stabilizing foundation system of claim 15, wherein:
the substrate is a first substrate;
the second magnetic element of the receiving unit includes the plurality of segregated magnets;
the receiving unit further includes a first peel-and-stick adhesive pad disposed above an upper side of the first substrate and including a first adhesive layer and a first peel-off layer, the first adhesive layer is exposed when the first peel-off layer is peeled off, the exposed first adhesive layer is adhered to an upper surface of the first substrate.

17. The stabilizing foundation system of claim 16, wherein the receiving unit further includes a second peel-and-stick adhesive pad disposed on an opposite side of the first substrate, the second peel-and-stick adhesive pad including a second adhesive layer adhered to a lower surface of the first substrate, a second substrate, a third adhesive layer disposed at a lower surface of the second substrate, and a second peel-off layer, the third adhesive layer being exposed when the second peel-off layer is peeled off, and configured to adhere to the article sufficiently to attach the receiving unit to the article.

18. The stabilizing foundation system of claim 1, wherein the first magnetic element of the base unit is a ferromagnetic plate, and the second magnetic element comprises a plurality of magnets, each having a smaller horizontal profile than that of ferromagnetic plate, each of the plurality of magnets being magnetically coupled to the ferromagnetic plate when the article is atop the base unit.

19. A system comprising:
an outdoor-use article;
a base unit having a first side configured to be adhered to a surface below the article via a peel-and-stick adhesive pad of the base unit, the base unit including a first magnetic element; and
a receiving unit, including a second magnetic element, configured to be affixed to a bottom portion of the article;
wherein the first or second magnetic element is a magnet, the other of the first or second magnetic element is an attracting magnet or a ferromagnetic plate, and the first and second magnetic elements are configured to engage each other, thereby securing the article to the surface via a magnetizing force.

20. A stabilizing foundation system for securing an outdoor-use article to a surface below the article, the system comprising:
a magnetic adhesive adherable to the surface; and
a receiving unit configured to be affixed to a bottom portion of the article, the receiving unit including a magnetic element,
wherein the magnetic element and the magnetic adhesive are configured to magnetically attract each other, thereby securing the article to the surface via a magnetizing force.
